(19) United States
(12) Patent Application Publication
(10) Pub. No.: US 2023/0421036 A1
(43) Pub. Date: Dec. 28, 2023

(54) LINEAR MOTOR

(71) Applicant: DENSO CORPORATION, Kariya-city (JP)

(72) Inventors: Itsuki FUNABA, Kariya-city (JP); Taichi SUGIURA, Kariya-city (JP); Shin SAKAI, Kariya-city (JP); Mitsuo HARA, Kariya-city (JP); Akitomo SASAKI, Kariya-city (JP); Kenta OSANAI, Kariya-city (JP); Kenichiro BAN, Kariya-city (JP)

(73) Assignee: DENSO CORPORATION, Kariya-city (JP)

(21) Appl. No.: 18/368,072

(22) Filed: Sep. 14, 2023

Related U.S. Application Data
(63) Continuation of application No. PCT/JP2022/012440, filed on Mar. 17, 2022.

(30) Foreign Application Priority Data
Mar. 19, 2021 (JP) 2021-046242

(51) Int. Cl. H02K 41/03

(52) U.S. Cl. CPC H02K 41/031

(57) ABSTRACT

Disclosed is a linear motor which includes a stator and a mover. The stator extends along a first axis. The mover is arranged so as to extend along the first axis and radially face the stator. The mover has a pole interval along the first axis different from that of the stator. At least one of the stator and the mover has a plurality of permanent magnets arranged in alignment with each other along the first axis, and a plurality of yoke parts arranged in alignment with each other along the first axis. The permanent magnets are provided, for each pole, in a continuous range along the first axis. The permanent magnets are polar anisotropic magnets that are magnetized from both end portions along the first axis to a radial end portion at a center along the first axis, or magnetized in the reverse directions to these.

### CROSS-REFERENCE TO RELATED APPLICATIONS

The present application is a continuation application of International Application No. PCT/JP2022/012440 filed on Mar. 17, 2022, which is based on and claims priority from Japanese Patent Application No. 2021-046242 filed on Mar. 19, 2021. The entire contents of these applications are incorporated by reference into the present application.

### BACKGROUND

### 1 Technical Field

The present disclosure relates to linear motors.

### 2 Description of Related Art

Conventionally, linear motors have been known which include a stator extending along a first axis, and a mover arranged so as to extend along the first axis and radially face the stator; the mover has a pole interval along the first axis different from that of the stator.

In these linear motors, at least one of the stator and the mover has a plurality of permanent magnets arranged in alignment with each other along the first axis, and a plurality of yoke parts arranged in alignment with each other along the first axis. Moreover, for each pole, there are provided two permanent magnets which are magnetized in mutually opposite directions and between which one yoke part is interposed.

### SUMMARY

A linear motor according to the present disclosure includes a stator and a mover. The stator extends along a first axis. The mover is arranged so as to extend along the first axis and radially face the stator. The mover has a pole interval along the first axis different from that of the stator. At least one of the stator and the mover has a plurality of permanent magnets arranged in alignment with each other along the first axis, and a plurality of yoke parts arranged in alignment with each other along the first axis. The permanent magnets are provided, for each pole, in a continuous range along the first axis. The permanent magnets are polar anisotropic magnets that are magnetized from both end portions along the first axis to a radial end portion at a center along the first axis, or magnetized in the reverse directions to these.

### BRIEF DESCRIPTION OF THE DRAWINGS

FIG. 1 is a cross-sectional view of a linear motor according to an embodiment.

FIG. 2 is a partially exploded perspective view of a stator of the linear motor according to the embodiment.

FIG. 3 is a partially exploded perspective view of a mover of the linear motor according to the embodiment.

FIG. 4 is a cross-sectional view of part of the linear motor according to the embodiment.

FIG. 5 is a partially exploded perspective view of a mover of a linear motor according to a modification.

FIG. 6 is a cross-sectional view of part of a linear motor according to another modification.

### DESCRIPTION OF EMBODIMENTS

In the above-described linear motors known in the art (see, for example, Japanese Unexamined Patent Application Publication No. JP2012244688A), for each pole, there are provided two permanent magnets with one yoke part interposed therebetween; and the two permanent magnets are magnetized in mutually repulsive directions. Consequently, there are problems such that the number of parts is increased and the assembly is difficult.

The present disclosure has been accomplished in view of the above problems.

With the configuration of the above-described linear motor according to the present disclosure, the permanent magnets are provided, for each pole, in the continuous range along the first axis; and the permanent magnets are the polar anisotropic magnets that are magnetized from both the end portions along the first axis to the radial end portion at the center along the first axis, or magnetized in the reverse directions to these. Consequently, it becomes possible to reduce the number of parts. That is, with the configuration, compared to, for example, the conventional configuration where permanent magnets are provided, for each pole, in two ranges and a yoke part is interposed between the permanent magnets, it becomes unnecessary to have a yoke part interposed between permanent magnets in each pole and thus becomes possible to reduce the number of parts. Moreover, compared to, for example, the conventional configuration where each pole is formed by assembling two permanent magnets magnetized in mutually repulsive directions, it becomes possible to improve the assemblability.

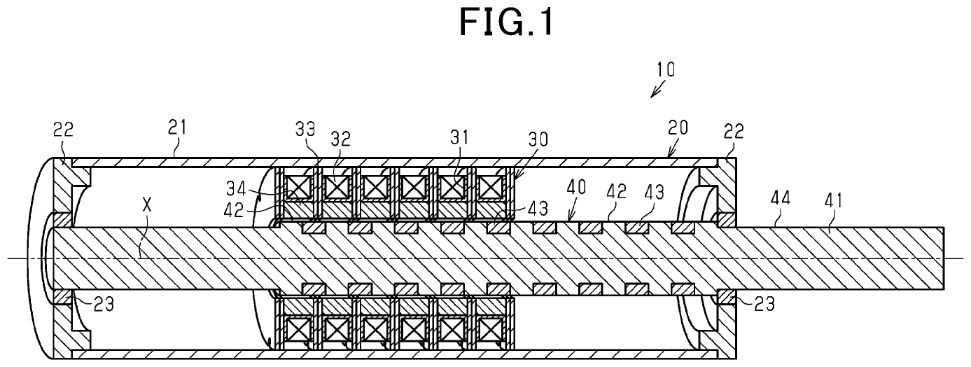

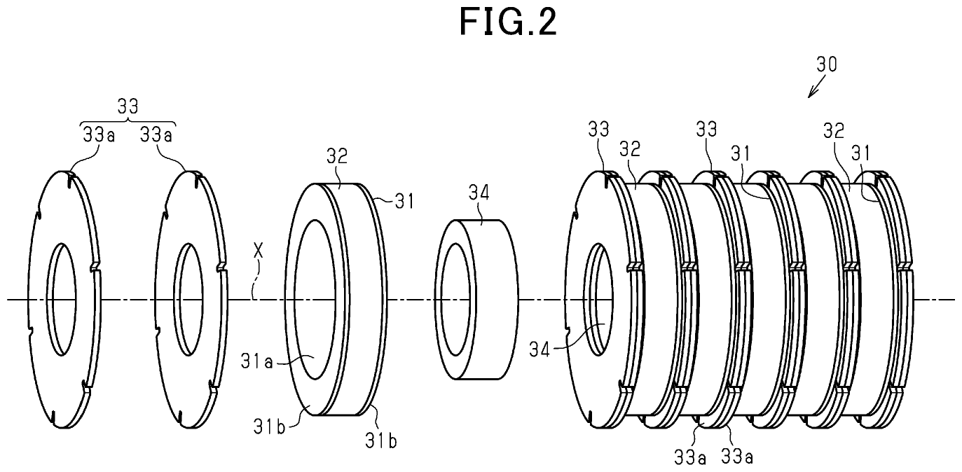

Hereinafter, a linear motor 10 according to an embodiment will be described with reference to FIGS. 1 to 4. As shown in FIG. 1, the linear motor 10 includes a housing 20, a stator 30 and a mover 40.

The housing 20 has a tubular case 21 extending along a first axis X, discoid end housings 22 closing both ends of the case 21, and tubular sliding bearings 23 provided respectively at centers of the end housings 22.

The stator 30 extends along the first axis X. The stator 30 has a tubular overall shape and is fixed to an inner circumferential surface of the case 21. Specifically, as shown in FIGS. 1, 2 and 4, the stator 30 has a plurality of insulators 31 arranged in alignment with each other along the first axis X, a plurality of coils 32 arranged in alignment with each other along the first axis X, a plurality of first yoke parts 33 arranged in alignment with each other along the first axis X, and a plurality of first permanent magnets 34 arranged in alignment with each other along the first axis X.

The insulators 31 are made of an electrically-insulative resin material. Each of the insulators 31 has a tubular portion 31a and flange portions 31b extending radially outward from both ends of the tubular portion 31a. Each of the coils 32 is wound around the tubular portion 31a of a corresponding one of the insulators 31 so as to be interposed between the flange portions 31b of the corresponding insulator 31. In the present embodiment, there are provided six coils 32, i.e., U-phase, V-phase, W-phase, −U-phase, −V-phase and −W-phase coils 32. Moreover, three-phase drive currents having different phases are supplied from a drive circuit (not shown) to the coils 32 of the respective phases.

The first yoke parts 33 are made of a soft-magnetic material. In the present embodiment, each of the first yoke parts 33 is constituted of two discoid core sheets 33a that are superposed on each other. The first yoke parts 33 are provided at both ends of each of the coils 32 so as to be placed in contact with the flange portions 31b of the insulators 31. That is, in the present embodiment, there are provided seven first yoke parts 33, with the coils 32 interposed therebetween. Moreover, each corresponding pair of one of the coils 32 and one of the first yoke parts 33 constitutes one pole of the stator 30. Accordingly, in the present embodiment, the stator 30 has a total of six poles.

The first permanent magnets 34 are formed in a tubular shape and located radially inside the coils 32, more specifically located radially inside the tubular portions 31a of the insulators 31. For each of the poles of the stator 30, there is provided only one of the first permanent magnets 34 in a continuous range along the first axis X.

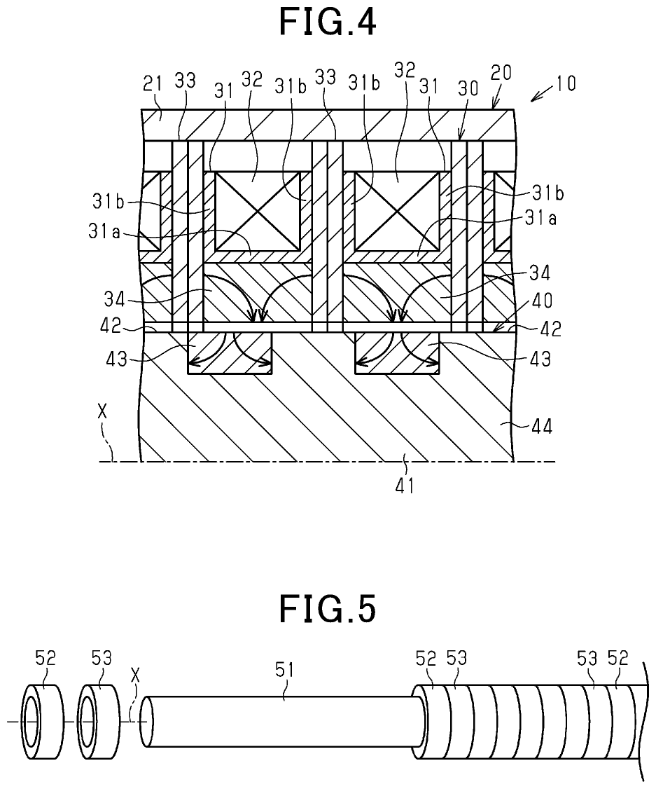

As shown in FIG. 4, each of the first permanent magnets 34 is a polar anisotropic magnet that is magnetized from both end portions along the first axis X to a radial end portion at a center along the first axis X, more particularly to a radially inner end portion at the center along the first axis X. That is, each of the first permanent magnets 34 has both the end portions along the first axis X magnetized into S poles and the radially inner end portion at the center along the first axis X magnetized into an N pole.

The stator 30 has the outer peripheries of the first yoke parts 33 fixed to the inner circumferential surface of the case 21. The mover 40 is arranged so as to extend along the first axis X and radially face the stator 30. Moreover, the mover 40 has a pole interval along the first axis X set to be different from that of the stator 30.

Specifically, as shown in FIGS. 1, 3 and 4, the mover 40 has a shaft part 41 extending along the first axis X, a plurality of second yoke parts 42 arranged in alignment with each other along the first axis X, and a plurality of second permanent magnets 43 arranged in alignment with each other along the first axis X.

In the present embodiment, the shaft part 41 and the second yoke parts 42 are integrally formed into a single-piece part 44. The single-piece part 44, which includes the shaft part 41 and the second yoke parts 42, is made of a soft-magnetic material. Each of the second yoke parts 42 extends radially outward from the shaft part 41. In the present embodiment, there are provided ten second yoke parts 42 in alignment with each other along the first axis X.

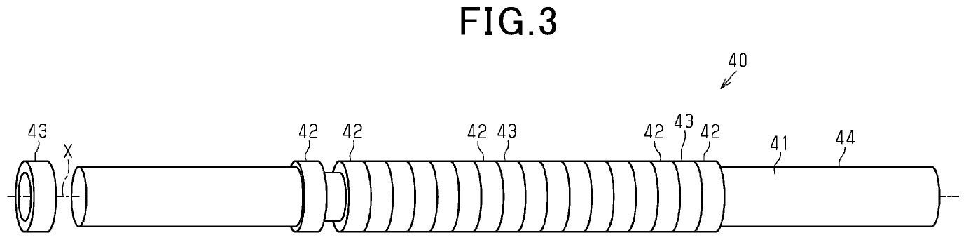

Each of the second permanent magnets 43 is formed in a tubular shape and located radially outside the shaft part 41 so as to be sandwiched between an adjacent pair of the second yoke parts 42. In the present embodiment, there are provided nine second permanent magnets 43 in alignment with each other along the first axis X. Moreover, in the present embodiment, the second permanent magnets 43 are formed as bonded magnets. That is, the second permanent magnets 43 are magnets that are formed by mixing minute magnet particles with resin or the like and filling them into the spaces between the second yoke parts 42. It should be noted that: the second permanent magnets 43 cannot be disassembled from the single-piece part 44 without being damaged; however, in FIG. 3, for the sake of facilitating understanding, one of the second permanent magnets 43 is schematically shown in an exploded manner.

As shown in FIG. 4, each of the second permanent magnets 43 is a polar anisotropic magnet that is magnetized from a radial end portion at a center along the first axis X, more particularly from a radially outer end portion at the center along the first axis X to both end portions along the first axis X. That is, each of the second permanent magnets 43 has the radially outer end portion at the center along the first axis X magnetized into an S pole and both the end portions along the first axis X magnetized into N poles. Consequently, each of the second yoke parts 42 has a radially outer end portion magnetized into an N pole.

With the above configuration, each corresponding pair of one of the second permanent magnets 43 and one of the second yoke parts 42 constitutes one pole of the mover 40. That is, for each of the poles of the mover 40, there is provided only one of the second permanent magnets 43 in a continuous range along the first axis X. Moreover, the pole interval of the mover 40 along the first axis X is set to be different from that of the stator 30. More particularly, in the present embodiment, the interval of the six poles of the stator 30 is set to be equal to the interval of five poles of the mover 40. That is, the interval of each pole of the mover 40 along the first axis X is set to be 1.2 times the interval of each pole of the stator 30 along the first axis X.

As shown in FIG. 1, the mover 40 is supported by the sliding bearings 23 on both end sides of the shaft part 41 so as to be movable in a direction along the first axis X.

Next, explanation will be given of operation of the linear motor 10 configured as described above.

Upon the three-phase drive currents being supplied from the drive circuit (not shown) to the coils 32 of the respective phases, the stator 30 generates a moving magnetic field, thereby moving the mover 40 along the first axis X.

Next, advantageous effects of the present embodiment will be described below.

(1) In the present embodiment, the first permanent magnets 34 are provided, for each pole of the stator 30, in a continuous range along the first axis X. Each of the first permanent magnets 34 is a polar anisotropic magnet that is magnetized from both end portions along the first axis X to a radial end portion at the center along the first axis X. Moreover, the second permanent magnets 43 are provided, for each pole of the mover 40, in a continuous range along the first axis X. Each of the second permanent magnets 43 is a polar anisotropic magnet that is magnetized from a radial end portion at the center along the first axis X to both end portions along the first axis X. Consequently, it becomes possible to reduce the number of parts. That is, with the above configuration, compared to, for example, the conventional configuration where permanent magnets are provided, for each pole, in two ranges and a yoke part is interposed between the permanent magnets, it becomes unnecessary to have a yoke part interposed between permanent magnets in each pole and thus becomes possible to reduce the number of parts. Moreover, compared to, for example, the conventional configuration where each pole is formed by assembling two permanent magnets magnetized in mutually repulsive directions, it becomes possible to improve the assemblability.

(2) In the present embodiment, for each pole of the stator 30, there is provided only one of the first permanent magnets 34. Consequently, it becomes possible to reduce the number of parts as compared with the case of providing, for each pole of the stator 30, two or more permanent magnets in a continuous range along the first axis X. Moreover, in the present embodiment, for each pole of the mover 40, there is provided only one of the second permanent magnets 43. Consequently, it becomes possible to reduce the number of parts as compared with the case of providing, for each pole of the mover 40, two or more permanent magnets in a continuous range along the first axis X.

(3) In the present embodiment, in both the stator 30 and the mover 40, there are provided the polar anisotropic magnets, i.e., the first permanent magnets 34 and the second permanent magnets 43. Consequently, it becomes possible to improve the efficiency of the linear motor 10 while reducing the number of parts and improving the assemblability of both the stator 30 and the mover 40, as compared with the case of providing polar anisotropic magnets in only one of the stator 30 and the mover 40.

(4) In the present embodiment, the shaft part 41 and the second yoke parts 42 are integrally formed into the single-piece part 44. Consequently, it becomes possible to reduce the number of parts as compared with the case of forming the shaft part 41 and the second yoke parts 42 separately.

(5) In the present embodiment, the second permanent magnets 43, which are the polar anisotropic magnets arranged between the second yoke parts 42 that are formed integrally with the shaft part 41 into the single-piece part 44, are formed as bonded magnets. Consequently, it becomes possible to easily provide the second permanent magnets 43 between the second yoke parts 42 as compared with the case of forming the second permanent magnets 43 as sintered magnets.

The above-described embodiment can be modified and implemented as follows. Moreover, the above-described embodiment and the following modifications can also be implemented in combination with each other to the extent that there is no technical contradiction between them.

In the above-described embodiment, the shaft part 41 and the second yoke parts 42 are integrally formed into the single-piece part 44. However, the present disclosure is not limited to this configuration. Alternatively, the shaft part and the second yoke parts may be formed as separate parts from each other.

For example, in a modification shown in FIG. 5, the shaft part 51 and the second yoke parts 52 are formed as separate parts from each other. Moreover, in this modification, the second permanent magnets 53, which are polar anisotropic magnets, are formed as sintered magnets, not as bonded magnets. The second yoke parts 52 and the second permanent magnets 53 are alternately fitted and fixed on the shaft part 51. Consequently, it becomes possible to easily and sequentially assemble the second yoke parts 52 and the second permanent magnets 53 to the shaft part 51. In addition, in this case, the shaft part 51 may be formed of a nonmagnetic material.

In the above-described embodiment, for each pole of the stator 30, there is provided only one first permanent magnet 34; and for each pole of the mover 40, there is provided only one second permanent magnet 43. Alternatively, for each pole, there may be provided two or more permanent magnets in a continuous range along the first axis X.

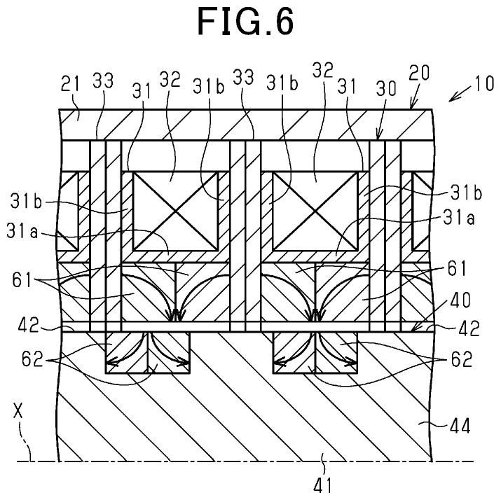

For example, in a modification shown in FIG. 6, for each pole of the stator 30, there are provided two first permanent magnets 61 in a continuous range along the first axis X. The first permanent magnets 61 are polar anisotropic magnets that are magnetized, in the range, from both end portions along the first axis X to a radial end portion at the center along the first axis X. That is, the two first permanent magnets 61 may be obtained by dividing one first permanent magnet 34 according to the above-described embodiment at the center along the first axis X.

Moreover, in the modification shown in FIG. 6, for each pole of the mover 40, there are provided two second permanent magnets 62 in a continuous range along the first axis X. The two second permanent magnets 62 are polar anisotropic magnets that are magnetized, in the range, from a radial end portion at the center along the first axis X to both end portions along the first axis X. That is, the two second permanent magnets 62 may be obtained by dividing one second permanent magnet 43 according to the above-described embodiment at the center along the first axis X.

With the above configuration shown in FIG. 6, compared to, for example, the conventional configuration where permanent magnets are provided, for each pole, in two ranges and a yoke part is interposed between the permanent magnets, it becomes unnecessary to have a yoke part interposed between permanent magnets in each pole and thus becomes possible to reduce the number of parts. Moreover, compared to, for example, the conventional configuration where each pole is formed by assembling two permanent magnets magnetized in mutually repulsive directions, it becomes possible to improve the assemblability.

In the above-described embodiment, in both the stator 30 and the mover 40, there are provided the polar anisotropic magnets, i.e., the first permanent magnets 34 and the second permanent magnets 43. However, polar anisotropic magnets may be provided in only one of the stator 30 and the mover 40. That is, either the first permanent magnets 34 of the stator 30 or the second permanent magnets 43 of the mover 40 may be omitted from the configuration of the linear motor 10. For example, the mover 40 may be modified to have only salient poles formed of a soft-magnetic material, without having the second permanent magnets 43. Otherwise, the mover 40 may be modified to have permanent magnets that are not polar anisotropic magnets, instead of the second permanent magnets 43 that are polar anisotropic magnets. Alternatively, the stator 30 may be modified to have permanent magnets that are not polar anisotropic magnets, instead of the first permanent magnets 34 that are polar anisotropic magnets.

In the above-described embodiment, the stator 30 has a total of six poles. However, the number of poles of the stator 30 may alternatively be set to other numbers. Moreover, in the above-described embodiment, the pole interval of the mover 40 along the first axis X is set to be 1.2 times the pole interval of the stator 30 along the first axis X. However, the pole interval of the mover 40 may be changed according to, for example, the number of poles of the stator 30. Furthermore, in the above-described embodiment, the mover 40 has ten second yoke parts 42 and nine second permanent magnets 43 interposed between the second yoke parts 42. However, the mover 40 may alternatively have a different number of the second yoke parts 42 and a different number of the second permanent magnets 43.

In the above-described embodiment, each of the first yoke parts 33 is constituted of two discoid core sheets 33a that are superposed on each other. However, the first yoke parts 33 may alternatively have other configurations.

In the above-described embodiment, each of the first permanent magnets 34 is a polar anisotropic magnet that is magnetized from both end portions along the first axis X to a radial end portion at the center along the first axis X. However, each of the first permanent magnets 34 may alternatively be a polar anisotropic magnet that is magnetized in directions reverse to the aforementioned directions.

In the above-described embodiment, each of the second permanent magnets 43 is a polar anisotropic magnet that is magnetized from a radial end portion at the center along the first axis X to both end portions along the first axis X. However, each of the second permanent magnets 43 may alternatively be a polar anisotropic magnet that is magnetized in directions reverse to the aforementioned directions.

It should be noted that the expression “at least one of A and B” in the present disclosure should be understood as meaning “only A, only B, or both A and B”.

While the above particular embodiment and its modifications have been shown and described, it will be understood by those skilled in the art that various further modifications, changes, and improvements may be made without departing from the spirit of the present invention.

What is claimed is:

1. A linear motor comprising:
a stator extending along a first axis; and
a mover arranged so as to extend along the first axis and radially face the stator, the mover having a pole interval along the first axis different from that of the stator,
wherein:
at least one of the stator and the mover has a plurality of permanent magnets arranged in alignment with each other along the first axis, and a plurality of yoke parts arranged in alignment with each other along the first axis;
the permanent magnets are provided, for each pole, in a continuous range along the first axis; and
the permanent magnets are polar anisotropic magnets that are magnetized from both end portions along the first axis to a radial end portion at a center along the first axis, or magnetized in the reverse directions to these.

2. The linear motor as set forth in claim 1, wherein:
for each pole, there is provided only one of the permanent magnets.

3. The linear motor as set forth in claim 1, wherein:
the permanent magnets, which are the polar anisotropic magnets, are provided in both the stator and the mover.

4. The linear motor as set forth in claim 1, wherein:
the mover has a shaft part extending along the first axis; and
the shaft part and the yoke parts are integrally formed into a single-piece part.

5. The linear motor as set forth in claim 4, wherein:
the permanent magnets, which are the polar anisotropic magnets arranged between the yoke parts, are formed as bonded magnets.

6. The linear motor as set forth in claim 1, wherein:
the mover has a shaft part extending along the first axis; and
the shaft part and the yoke parts are formed as separate parts from each other.
